(19) United States
(12) Patent Application Publication
(10) Pub. No.: US 2026/0295442 A1
(43) Pub. Date: Oct. 1, 2026

(54) SIMULATED STATE DRIVEN NEURAL RENDERING FOR SPECTATING GAMEPLAY

(71) Applicant: Electronic Arts, Inc., Redwood City, CA (US)

(72) Inventor: Kallol Mitra, Vancouver (CA)

(73) Assignee: Electronic Arts, Inc., Redwood City, CA (US)

(21) Appl. No.: 19/092,068

(22) Filed: Mar. 27, 2025

(51) Int. Cl. A63F 13/86; A63F 13/497; A63F 13/525

(52) U.S. Cl. CPC A63F 13/86; A63F 13/497; A63F 13/525

(57) ABSTRACT

Systems and methods of streaming simulated state data of a virtual interactive environment for spectating gameplay supporting visual modifications. A video game application transmits simulated state data to a spectating application that includes a machine learning model trained to render gameplay from the simulated state data. Through local client-side rendering of the spectated gameplay, the spectating application can offer interactive features for engaging with and changing visual aspects of the rendered frames, unlike traditional video streaming. The spectating application utilizes a neural renderer to generate high-fidelity visuals without requiring full game assets, maintaining smooth motion through state interpolation and supporting multiple synchronized viewpoints. By streaming simulated state data packets, the approach reduces bandwidth, software, and hardware requirements for locally rendering spectated gameplay.

### BACKGROUND

Video streaming allows spectators to watch the gameplay of other players through streaming services. However, these gameplay video streams require spectators to have access to a high bandwidth connections and limit spectators'abilities to interact with the spectated gameplay. Providing interactive features to spectators requires spectating gameplay through video game applications, which can require particular computing devices such as video game consoles. Therefore, there is a need for systems and methods that enable interactive spectating features while minimizing network bandwidth, software, and hardware requirements.

### SUMMARY

The systems, methods, and devices of this disclosure each have several innovative aspects, no single one of which is solely responsible for all the desirable attributes disclosed herein.

Aspects of the present disclosure correspond to game data driven neural rendering to create an interactive spectating experience of gameplay that minimizes bandwidth and hardware requirements. Game data, which includes details that define or comprise the states of gameplay, is used to render the gameplay among a spectating application, among other things.

One example embodiment includes systems, methods, and computer readable mediums of a spectating application configured to access, from a spectating service over a network to display the spectating application, a plurality of game sessions corresponding to one or more video game applications, wherein the plurality of game sessions is each available for spectating; select, from among the accessed plurality of game sessions displayed on the spectating application, a game session among the plurality to spectate the gameplay of; send, in response to the selection of the game session, a request to spectate the gameplay of the game session to the spectating service; receive, in response to the request, a data stream corresponding to the game session from the spectating service, the data stream comprising at least simulation state data packets (SSDPs) defining one or more states of gameplay of the game session; render, by a renderer of the spectating application, a first view of gameplay based at least in part on the data stream, wherein the renderer of the spectating application differs from the render of the video game application; select, among a user interface of the spectating application, a first visual modification feature to apply to the first view rendered; and render a second view of gameplay based at least in part on the data stream and the first visual modification feature, wherein the second view renders at least one or more visual elements that differ from the first view.

### BRIEF DESCRIPTION OF THE DRAWINGS

This disclosure is better understood from the following detailed description taken in conjunction with the accompanying drawings, in which:

FIG. 1 is a system diagram of a software environment for spectating gameplay according to an example embodiment.

FIG. 2 is a system diagram of a software environment for communicating game state data for spectating gameplay according to an example embodiment.

FIG. 3 is a flowchart diagram of game state data communication for spectating gameplay according to an example embodiment.

FIG. 4 is a process diagram of rendering gameplay from game state data for spectating according to an example embodiment.

FIG. 5A is a system diagram of configuring a renderer for spectating gameplay according to an example embodiment.

FIG. 5B is a system diagram of the inputs provided to a renderer for spectating gameplay according to an example embodiment.

FIG. 6 is an illustration of a first exemplary rendering feature according to an example embodiment.

FIG. 7 is an illustration of a second exemplary rendering feature according to an example embodiment.

FIG. 8 is an illustration of a third exemplary rendering feature according to an example embodiment; and

FIG. 9 is a diagram of an example computing device usable to perform any of the methods described herein, including for spectating gameplay.

### DETAILED DESCRIPTION

The systems and methods described herein correspond to streaming simulated state data of a virtual interactive environment-such as a video game and/or virtual social space-to be spectated on a spectating application through rendering techniques that enable visual modifications of the spectated virtual interactive environment.

Traditional rendering techniques of modern video games use complex rendering pipelines to render gameplay, which require specific software and/or hardware to operate. Additionally, a video game engine and/or rendering pipeline of a video game require game assets to be quickly streamed into memory to render the visuals in each frame, which require many game assets to be saved (e.g., stored) among a data store of a computing device, often requiring large memory capacity.

Common methods of streaming gameplay of video games rely on traditional streaming techniques, which undergo subsequent compression, decompression, encoding, decoding, and/or transmission that contribute to high latency, in addition to requiring high bandwidth for the streaming of large video data. In contrast to this approach, which require a video game engine (hereinafter “game engine” in short) to fully render frames prior to them being encoded for streaming, the disclosed system transmits simulated state data to a spectating application that includes a machine learning model trained to render gameplay without further processing through game engine or video encoder, and without requiring all the game assets be locally saved to computing device running the spectating application. While multiplayer games can stream and receive state data from one another, for either participating in or spectating gameplay, this approach still requires a video game application to be fully installed on a computing device capable of playing the video game application, which may be hardware for execution (i.e., a video game console).

Accordingly, the systems and methods described herein reduce bandwidth, software, and hardware requirements for locally rendering spectated gameplay. Additionally, by providing local (or “client-side”) rendering of the spectated gameplay—which renders or constructs the frames corresponding to gameplay dynamically as they simulated state data packets are received—the spectating application can provide one or more interactive features for engaging with and/or changing the one or more visual aspects of rendered frames (e.g., visual elements or visual content of the game).

As used herein, to “spectate” gameplay means that a user (e.g., a spectator) can watch the gameplay of a video game in real time or near real time (e.g., synchronously). Accordingly, “spectating” gameplay also includes watching the gameplay of a previously played gameplay session of a video game as a replay (e.g., asynchronously). Moreover, the terms spectating and spectate can also refer to the facilitation, transmission, and/or use of data to render and/or display frames corresponding to the gameplay of a video game so that it can be watched by a user. For example, spectating gameplay or game session-such as on a software application-includes requesting and receiving a stream of data over a network, and using the stream of data to render and/or display gameplay as a sequence of frames, among other things.

### System Overview

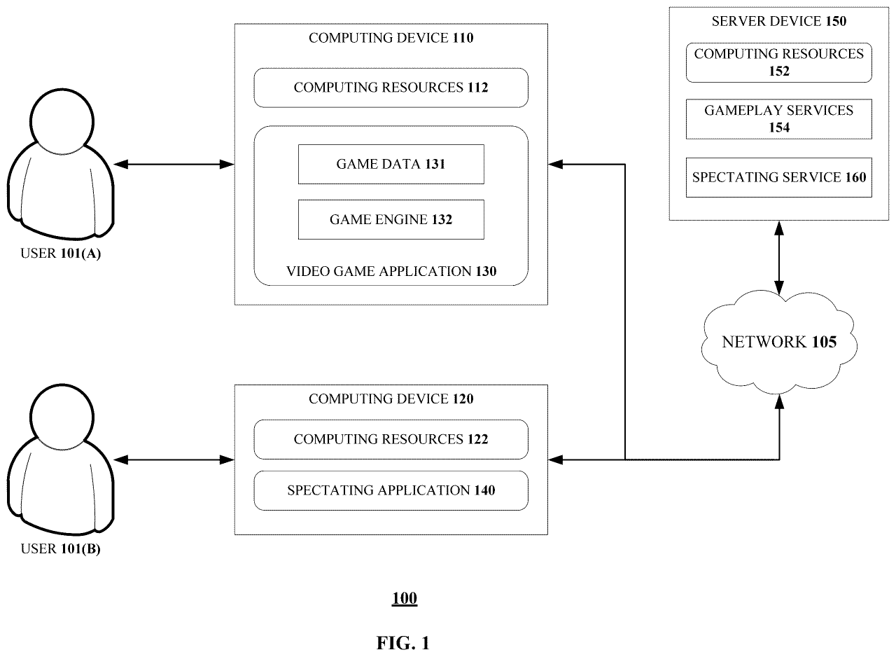

FIG. 1 is a system diagram of a software environment 100 according to an example embodiment. Software environment 100 illustrates a system architecture to spectate gameplay from a video game application (or “video game” in short) over a network, including computing device 110 and 120, Server Device 150, and network 105.

As shown in FIG. 1, software environment 100 includes computing devices 110 and 120 that are associated with—or operated and/or controlled by—user 101(A) and user 101(B), respectively. As known to those of skill in the art, users can operate or control a computing device through inputs provided via input devices of, or associated with, the computing device. For instance, users 101(A) and 101(B) can provide inputs to computing devices 110 and 120 respectively-through one or more input devices (e.g., controller, keyboard, mouse, touchscreen, camera, microphone, etc.). Additionally, computing devices 110 and 120 can output, communicate, and/or provide information (e.g., display, render, play audio) to users through one or more output devices (e.g., monitor, screen, touchscreen, speaker, haptics, etc.) of, or associated with, the computing device.

Users 101(A) and 101(B) can be a player, spectator, and/or an automated agent (hereinafter “agent” in short). The term “player” corresponds to a user of a video game application, whereas a “spectator” can correspond to a user of a spectating application. As known to a person of ordinary skill in the art, an “agent” can include a machine learning model and/or software to automate or perform one or more tasks (e.g., playing or testing a video game). For instance, agents can function as users and be deployed, controlled, and/or directed by a computing device to perform and/or automate one or more tasks through common techniques known to those of skill in the art.

Computing devices 110 and 120 can be or include any one or a combination of systems known to those of skill in the art, including, for example, a desktop, laptop, game application platform, game console, virtual reality system, augmented reality system, television set-top box, television, network-enabled kiosk, car-console devices computerized appliance, wearable device (e.g., smart watch, glasses with computing functionality), and wireless mobile devices (e.g., smart phones, PDAs, tablets). Computing devices 110 and 120 can store and/or execute computer executable instructions (or code) of applications (or programs or software), such as video game applications, spectating applications, and/or other interactive applications known to those of skill in the art that could include or benefit from the systems and methods described herein.

Computing resources 112 and 122 of computing devices 110 and 120, respectively, include hardware and software that are configured to execute a video game application and spectating application, among other types of applications; including, for example, central processing units (CPUs), memory, mass storage, graphics processing units (GPUs), communication or networking components, input devices and/or output devices (I/O devices). In some embodiments, computing devices 110 and 120 can include any number and/or combination of computing resources-including those described herein and others known to those of skill in the art-that are configured to perform the systems and methods described herein.

Video game application 130 of computing device 110 includes data and software that provides gameplay and other features to users (or “players”) of a video game during execution. For example, executing video game application 130 can cause an instance of the video game to be generated. Each instance can be referred to as a “game session” or “gameplay session”. The game session can be made up of or include one or more virtual interactive environments. A virtual interactive environment can be or include one or more virtual levels, virtual social spaces, and/or graphical user interfaces that can be interacted with or in, for gameplay or socializing. As such, a game session can include, host, or enable—for users—participation and interaction by or with player characters, non-player characters, quests, objectives, and other features, elements, assets, objects, or other in-game entities of the like as known to those of ordinary skill in the art.

By way of example and not limitation, video game application 130 includes game data 131 and game engine 132. As known to a person of ordinary skill in the art, a game engine uses game data (e.g., state data, render data, simulation data, audio data, and other data types of the like) to generate game sessions and/or render one or more outputs (e.g., visual output, audio output, and haptic output) corresponding to gameplay to one or more computing devices. Game data 131 includes state data, simulation data, rendering data, audio data, animation data, and other data of the like-including game code-used and/or produced by or among game engine 132 during execution of video game application 130 to generating game sessions and rendering the corresponding gameplay to a player, thereby allows and/or enables players to interact and/or engage with one or more aspects of the video game.

In some embodiments, data correspond to gameplay of video game application 130 can be used in part for spectating the gameplay among another computer device and/or software application (e.g., computing device 120 and spectating application 140). For example, video game application 130 can stream data corresponding to gameplay to spectating service 160 and/or spectating application 140 to make the gameplay available for spectating. The data streamed by video game application 130 may include state data that corresponds to the state of the gameplay at, or near, the time it is streamed. Video game application 130 may also stream audio data and/or reference frame data.

Spectating application 140 of computing device 120 includes software for spectating gameplay of video gameplay application 130. For example, spectating application 140 can be configured to render gameplay based in part on state data of video game application 130. In some embodiments, spectating application includes a render that differs from the renderer of game engine 132 of video game application 130. For instance, the renderer of spectating service 160 can be a machine learning model trained and/or configured to render images and/or video of gameplay.

As known to a person of ordinary skill in the art, a machine learning model (e.g., a neural network) used to render visual content (e.g., images or video) is commonly known as a neural renderer: the technique of using a neural renderer to perform audio and/or visual rendering is known as neural rendering. In contrast to traditional rendering techniques used by game engines of video games, a neural renderer can be configured to render visual content without processing explicit modeling and/or simulation, as well as without requiring any particular game data. Accordingly, spectating application 140 can include a neural renderer configured to render visual content that corresponds to video game application 130 without requiring the processing performed by game engine 132 or data dependencies to game data 131. Therefore, a neural renderer of spectating application 140 can render visual content of video game application 130 with fewer harder and/or software resources and/or requirements. For example, spectating application 140 can render gameplay based in part on the data streamed by video game application 130.

Additionally, spectating application 140 is configured to receive user input (e.g., from User 101(B)). For example, a graphical user interface of spectating application enables interactivity and/or selection of features that change how the visual content corresponding to the streamed gameplay appears in frames rendered by the spectating application. In turn, this would allow the visual content presented to the spectator (e.g., user 101(B)) of computing device 120 to appear differently than to how it was originally presented to a player (e.g., user 101(A)) of computing device 120.

Network 105 includes any method of private and/or public connectivity, networking, and/or communication between or among hardware devices known in the arts. The network may be or include direct wired connections, Near Field Communication (NFC), a Local Area Network (LAN), a Virtual Private Network (VPN), an internet connection, or other communication methods known to those of skill in the art to communicatively couple computing devices. As illustrated, network 105 communicatively couples computing devices 110 and 120, and server device 150.

Server device 150 is a computing device including computing resources 152, which can be similar to the computing device 110 and computing resources 112. Server device 150 provides services to video game application 130 and/or spectating application 140. As known to a person of ordinary skill in the art, services (e.g., service applications) are software that provide functionality and/or data to other software applications. Services can be provided remotely over a network (commonly known as a “software as a service” or “SaaS” in short) or locally among a system. The server device 150 includes gameplay services 154 and spectating service 160 that corresponds to one or more aspects or features of a video game application 130 and/or spectating application 140.

Gameplay services 154 can include user account services, video game platform services, multiplayer game services, matchmaking services, communication services, data storage, and anti-fraud detection, and other video game services of the like. In turn, gameplay services 154 and server device 150 can be used to establish and maintain connections between and/or among computing devices, video game applications, and/or user accounts that, at least in part, facilitate multiplayer parties, communications, gameplay, and other video game features. For example, user accounts of a video game platform service include data provided by users, such as a username, which identifies a user among software environment 100 and enable user accounts to access and/or manage software and/or services corresponding to software environment 100, including video game application 130.

Spectating service 160 is a service that facilitates the spectating of gameplay between a video game application and a spectating application, such as video game application 130 and spectating application 140. In some embodiments, spectating service 160 is configured to receive data from video game application 130 (e.g., as a data stream) and send that data to spectating application 130 (e.g., as a data stream). The spectating service 160 can receive data from one or more video game applications, and can send data to one or more spectating applications. In some embodiments, spectating service 160 provides spectating application 140, or enables spectating application 140 to query for, a data set corresponding to gameplay that is available for spectating based on the data sent to spectating service 160 by each video game. Spectating service 160 can save and/or store data sent to it by one or more video game applications (e.g., 130) among one or more data stores (e.g., among server device 150) so that a spectator of a spectating application (e.g., 140) can asynchronously spectate the corresponding gameplay.

### Spectating System

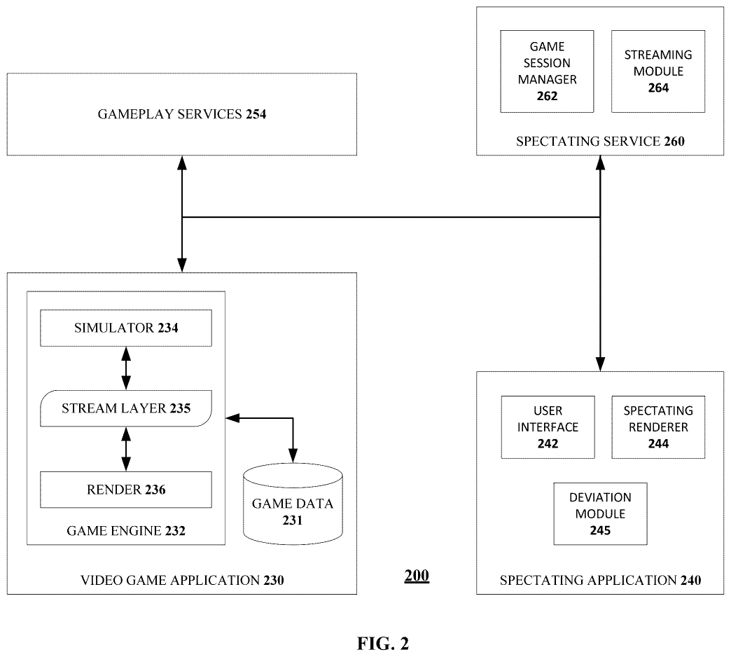

FIG. 2 is a diagram of system 200, which illustrates a system architecture to spectate gameplay from video game application 230 among spectating application 240, such as by streaming data corresponding to gameplay over a network. System 200 also includes gameplay services 254 and spectating service 260 which can, for example, be used at least in part to facilitate and/or spectate gameplay corresponding to video game application 230. For simplicity, by way of example and not limitation, system 200 illustrates only one of elements 230, 240, 254 and 260, but—as appreciated by one skilled in the art—multiple of these elements can each be communicatively coupled to one another among system 200—such as, for example, to facilitating multiplayer gameplay for one or more video game applications (230) and spectating by one or more spectating applications (240). In some embodiments, the elements of system 200 correspond to the elements of software environment 100 of FIG. 1, and their corresponding detailed description.

### Video Game Application

Video game application 230 includes software and data (game engine 232 and game data 231) comprising a video game that, when executed by a computing device, enables gameplay of the video game. In some embodiments, video game application 230 and its components are similar to the description of video game application 130 of FIG. 1.

### Game Engine

As illustrated in FIG. 2, by way of example and not limitation, game engine 232 includes simulator 234, stream layer 235, and renderer 236. Game engine 232 can be configured to operate on one or more virtual clock cycle that partitions processing into discrete time steps. As known to a person of ordinary skill in the art, each virtual clock cycle and/or discrete time step is commonly known as a “tick”. During a tick, game engine 232, may—for example—detect and process inputs, simulate states, and render gameplay, among other things. In some embodiments, game engine 232 has a global tick to which simulator 234, stream layer 235, and renderer 236 operate on. In alternative embodiments, simulator 234, stream layer 235, and renderer 236 operate individually on unique ticks.

### Simulator

Simulator 234 is a simulation engine, framework, and/or pipeline of game engine 232 that is configured for simulating states among a virtual interactive environment of the video game during gameplay. As such, simulator 234 ensures that state corresponding to one or more virtual objects, virtual characters, and virtual environments operate in accordance with the video game's rules, logic, and/or mechanics. For example, simulator 234 processes physics, animations, and other dynamic elements of a video game interactive, such that they feel responsive to player inputs, among other things.

Simulator 234 can be configured as a modular and extensible system that includes various subsystems and/or subcomponents that handle specific simulations aspects during gameplay—such as, but not limited to, collision detection, object movement, character animations, and environmental interactions—and work together to simulate the game as a whole. For example, for each tick corresponding to simulator 234, each subcomponent and/or processing thread can process, update, and/or simulate states that are assigned and/or designated to be updated in that tick. In turn, as simulations are completed by simulator 234, the simulated state data—in whole or in part—is packaged by simulator 234, herein referred to as “Simulation State Data Packets” or SSDPs in short. Accordingly, at each tick, one or more SSDPs can be generated by simulator 234 to capture, as a data structure, the state of virtual objects, virtual characters, and virtual interactive environments of a game session- or portions thereof corresponding to an instance and/or moment in time during gameplay (e.g., at one or more ticks).

In some embodiments, a structured dataset of an SSDP contains data such as integers, Boolean values, strings, arrays, pointers, etc., that identify or describe how to simulate an object, character, or environment over multiple ticks. This may include Asset_ID, Transform Data (Position, Rotation, Scale), World Position, Local Position, Animation State, Physics Properties (Velocity, Collision States), Environmental Variables (Lighting, Weather Conditions), and other related properties.

### Stream Layer

Stream layer 235 is configured to manage the facilitation and/or transfer of SSDPs between the simulator 234 and renderer 236. In some embodiments, stream layer 235 serves as an abstraction layer in game engine 232 to decouple simulation and rendering pipelines, thereby allowing simulator 234 and renderer 236 to operate at different frequencies (e.g., tick rates or virtual clock cycle rates) during runtime. Accordingly, renderer 236 reads SSDPs from the state stream to generate rendered frames for display. The simulator 234 does not communicate directly with the renderer 236; instead, it writes the finalized SSDP to the state stream, and the renderer 236 accesses the SSDP to render frames within the game application.

Stream layer 235 includes a stream manager component that efficiently handles the registration, memory allocation, and lifecycle management of SSDPs into one or more state streams of, or placed into, stream layer 235. The stream manager component ensures that SSDPs received from simulator 234 and are efficiently accessible to renderer 236. In some embodiments, each state stream corresponds to particular type of state data and/or SSDPs—such as Character, Lighting, Physics, and Environmental—so that it specifically tracks and/or bucketizes SSDPs corresponding to those respective aspects and/or assets of the game sessions during runtime. In turn, this approach allows the renderer to selectively access only the relevant SSDPs needed for reconstructing a frame at each tick.

Moreover, the stream manager component dynamically registers and initializes state streams as needed during runtime. Thereafter the stream manger component, allocates memory and manages SSDP persistence (e.g., in memory and/or among each state stream) to maintain optimal performance. As such, the stream manager component tracks SSDP usage, marking SSDPS for disposal when no longer required by renderer 236 to render a subsequent frame, ensuring stream layer 235 do not retain excess data to provide optimal memory efficiency. For example, a state stream can be place in volatile memory (e.g., cache memory) of a computing device playing a video game application—such as among a dedicated buffer that continually overwrites and/or removes SSDPs not consumed, or no longer needed, by renderer 236 from stream layer 235.

In some embodiments, SSDPs to reference game data resources like assets, animations, textures, levels, player character models, and other assets of the like that are associated with, and/or correspond to, states defined by the SSDP. By including references, such as pointers to game assets, stream layer 235 allows rendering pipeline to perform streaming of game assets into the rendering pipeline. Accordingly, by organizing SSDPs into distinct state streams, the system ensures modular data processing and efficient handling of game assets during runtime and/or rendering.

Furthermore, external state data received from gameplay services 254 that corresponds to a state of a multiplayer game can be processed by stream layer 235. In some embodiments, the stream manager component receives SSDPs from gameplay services 254, which can correspond to a multiplayer game session that video game application 230 is currently participating in and assigns the received SSDPs to corresponding state streams. In some embodiments, SSDPs received from gameplay services 254 that correspond to a multiplayer game session may be registered to a state stream designated for such SSDPs. Accordingly, in a game session of a multiplayer and/or online game, stream layer 235 also ensures the simulation of video game application 230 is accurately represented when rendered to display by appropriately managing both local game data and external game data.

In some embodiments, SSDPs can be streamed to another computing device and/or service device over a network for use by another software application or software service, such as a spectating application (240) and spectating service (260). In some embodiments, a game engine (232) and/or simulator (234) can be configured to stream or send SSDPs simultaneously, or nearly simultaneously, to stream layer (235), a data store, and other computing devices, including other software applications. Alternatively, SSDPs can be stored in non-volatile memory for persistent storage. By storing SSDPs in persistent storage, they can be asynchronously used and/or streamed to other computing devices, such as for spectating a “replay” of the corresponding gameplay.

### Renderer

Renderer 236 is an integral component of game engine 232, functioning as a render engine, framework, and/or pipeline designed to produce the visual elements of the video game. It processes data from the simulation and/or stream layer to generate the final graphics displayed on the screen. Consequently, renderer 236 manages tasks such as lighting, shading, texturing, occluding, post-processing effects, and other visual and/or graphic renderings of the like.

In some embodiments, renderer 236 encompasses various subsystems that address specific aspects of the rendering process. For instance, the lighting subsystem calculates the illumination within the game environment based on the positions and properties of light sources. The shading subsystem determines the color and texture of objects according to their material properties and prevailing lighting conditions. The texturing subsystem applies textures to object surfaces, enhancing detail and realism within the game world. Additionally, the post-processing subsystem implements effects such as motion blur, depth of field, and bloom to elevate the visual quality of the final image. Moreover, Renderer 236 supports advanced rendering techniques, including real-time ray tracing and global illumination, which offer more realistic lighting and shadows.

As detailed, renderer 236 operates independently from the simulation, enabling rendering processes to be conducted separately, thus allowing for interpolation and/or frame rendering at varying rates compared to the simulation rate of game engine 232. For example, if simulator 234 operates at 30 Hz and renderer 236 renders frames at 120 FPS (frames per second), renderer 236 can generate four frames per simulation cycle by interpolating the state data in SSDPs.

This distinction between state data and its graphical representation facilitates more efficient rendering, as renderer 236 can concentrate on frame generation without modifying the state data provided by simulator 234. In certain embodiments, renderer 236 utilizes game assets corresponding to and/or referenced by SSDPs to create all the visual content of a game session into a frame. Once consumed, the SSDPs can be cleaned up or flagged for deletion, ensuring the state stream remains efficient. In some embodiments, renderer 236 determines when a state data package is ready for disposal and removes packages from the state stream accordingly.

Renderer 236 may also incorporate audio rendering and/or an audio rendering component. This component is responsible for generating the auditory output of the game, processing data from the simulation and stream layer to produce immersive soundscapes. It manages spatial audio, sound effects, dialogue, and background music. The audio rendering process works in conjunction with, and/or synchronizes with, the visual rendering components of renderer 236, ensuring that audio cues align accurately with visual events in the game.

As appreciated by a person of ordinary skill in the art, the modularity of simulator 234, stream layer 235, and renderer 236 enables efficient maintenance and updates to game engine 232 of video game application 230, as individual modules or components can be changed and/or optimized in an update to video game application 230 without impacting other components. Similarly, where multiple versions of video game application 230 exist—such as versions specific to a particular computing device or sets of computing devices (e.g., video game console version and smartphone device version)—the individual components of game engine 232 can be optimized for each version accordingly, such as to meet particular computing resource requirements.

In some embodiments, the data, processes, and/or components corresponding to game engine 232 are used in part to train a machine learning model to generate and/or render frames corresponding to gameplay of video game application 230. Accordingly, associations between SSDPs and rendered frames of video game application 230—as produced and/or used by game engine 232, simulator 234, stream layer 235, and renderer 236—can be learned by a machine learning model during training to generate or render frames from SSDPs.

### Spectating Application

Spectating application 240 is software configured to provide real-time, near real-time, and/or asynchronous spectating of gameplay. Spectating application 240 is configured to render gameplay from SSDPs that correspond to the gameplay of a game session of video game application 230—which can be provided and/or streamed to spectating application 240 by video game application 230, gameplay services 254, and/or spectating service 260. The spectating application 240 includes user interface 242, input module 243, and spectating renderer 244 and deviation module 245.

User interface (UI) 242 is a module of spectating application 240 that provides users (e.g., spectators) one or more graphical user interfaces (GUIs) to interact with spectating application 240. Accordingly, user interface 242 provides one or more interactable menus that display available game sessions to spectate, as well as display one or more visual modification features. For example, visual modification features (or “visual modifications” in short) can enable spectators visually change one or more aspects of gameplay they are watching, including manipulating camera views, visual asset modifications, personalized overlays, and replay options. Accordingly, spectators can change viewpoints, alter game elements like time of day, apply visual filters, and swap visual assets, among other things. Additionally, spectators can pause, rewind, or replay moments and view real-time event overlays to better understand competitive matches. In some embodiments, if a spectator chooses a visual element modification to apply to spectated gameplay, module 242 can cause that visual modification to be an input to spectating renderer 244 for a particular duration of time and/or until changed by the spectator.

Spectating Renderer 244 generates and renders frames using SSDPs from the video game application, utilizing neural rendering models or lightweight pipelines for high-fidelity visuals without full game assets. It maintains smooth motion through state interpolation, supports multiple synchronized viewpoints, adjusts resolution based on conditions, and synchronizes audio streams with gameplay frames, providing a real-time, efficient spectating experience without requiring high-bandwidth video streaming.

Furthermore, spectating renderer 244 can be configured to apply interpolation techniques based on received SSDPs to ensure smooth and/or preferable framerate of the spectated gameplay. Alternatively, in some embodiments, spectating renderer 244 can be configured to perform image interpolation between the frames it renders, such as through image interpolation techniques known to persons of ordinary skill the art. In turn, by using one or more of these interpolation technique, spectating application 240 can improve framerates to reduce any perceptible latency and jitter that may occur, such as when fluctuating data conditions occur. For example, If SSDPs arrive out of order or are lost due to network disruptions, the spectating application performs predictive interpolation to reconstruct missing data. In extreme cases, a reference frame request is triggered to realign the rendered visuals with the original game state. In a multiplayer setting, SSDPs from multiple players are timestamped and synchronized before rendering. If discrepancies arise due to network latency, the spectating renderer interpolates missing frames based on prior SSDP data or temporarily defers rendering of affected objects. For example, by analyzing temporal data points, spectating renderer 244 can be configured to infer intermediate states among the SSDPs received, thereby interpolating the input data before rendering.

In some embodiments, spectating renderer 244 is supplemented by an audio stream to provide synchronized auditory feedback alongside the dynamically rendered gameplay visuals. While the SSDPs primarily carry simulation state data—including object positions, animations, physics interactions, and environmental conditions—audio data can be streamed separately as a compressed audio stream corresponding to in-game events. By decoupling audio transmission from traditional video streaming and pairing it with state-driven rendering, the spectating application ensures that audio cues such as character dialogue, environmental sounds, and game event effects (e.g., gunfire, explosions, or crowd reactions) are played concurrently with the reconstructed gameplay frames. This architecture maintains significantly lower bandwidth requirements compared to traditional video and audio streaming, as state data packets are far smaller than full-resolution video frames. Unlike conventional pixel-based streaming, which requires constant high-bandwidth encoding and decoding of video and audio data, SSDP-based spectating only requires periodic state updates and a lightweight compressed audio stream, allowing for a more efficient and scalable spectating experience—particularly in low-bandwidth environments or high-scale spectator scenarios.

As spectating renderer 244 processes SSDPs to generate frames with user-selected visual modifications, it can also render corresponding “estimated reference frames” that preserve the original state of the scene, without any visual alterations. These estimated reference frames serve as an adaptive baseline for deviation module 245, allowing it to compare the modified frames against a known, unmodified state rather than solely relying on historical reference frames from the video game application. By maintaining a continuous and/or semi-continuous feed of estimated reference frames, deviation module 245 can effectively track cumulative rendering discrepancies and determine when a request for an authoritative reference frame from the video game application is necessary. This approach ensures that deviation detection remains accurate even when the spectator applies extensive visual modifications.

Accordingly, deviation module 245 is configured monitors several parameters of deviation in estimated reference frames to determine when a reference frame request should be initiated. Given that the spectating renderer 244 primarily reconstructs visuals from SSDPs, rendering accuracy may gradually diminish, particularly when users apply extensive visual modifications beyond the inherent capabilities of SSDPs.

To prevent visual degradation, the deviation module 245 evaluates rendering conditions of estimated reference frames in comparison to rendered frames of spectating renderer 244 to determine the necessity for a reference frame to recalibrate rendering accuracy. In some embodiments, the deviation module 245 continuously or semi-continuously compares rendered frames with the last known or received estimated reference frame and is configured to requests a new reference frame if the pixel deviation exceeds a specified threshold (e.g., 5-10% deviation from expected object positions or lighting conditions).

Additionally, it tracks user-applied rendering transformations, such as significant lighting shifts, substantial terrain modifications, and the application of filters or alternate rendering styles. If these modifications exceed a predefined complexity threshold, the spectating application 240 requests a reference frame to validate visual integrity. In certain embodiments, reference frames serve as occasional corrections rather than primary rendering sources. Therefore, SSDP-based rendering remains the primary method, with reference frames utilized solely for recalibration of the spectating renderer as needed.

In some embodiments, to balance bandwidth efficiency with rendering accuracy, the deviation module 245 determines the optimal frequency for reference frame requests based on current rendering conditions. Embodiments of reference frame intervals include every 10-30 seconds during normal spectating, every 3-5 seconds when significant modifications occur, and immediate on-demand requests when a major environmental shift or extreme rendering discrepancy is detected. By intelligently balancing SSDP-based rendering with reference frame validation, the spectating application 240 maintains high efficiency, customization, and fidelity without incurring unnecessary bandwidth costs. The deviation module 245 plays a critical role in ensuring that spectators receive an optimized, low-latency, and visually accurate representation of gameplay, reinforcing the advantages of state-based rendering over traditional pixel-streamed game spectating.

Additionally, when SSDP updates slow down due to network fluctuations or insufficient state changes, the deviation module 245 compensates by requesting a reference frame to interpolate missing details. It also detects frequent camera transitions that may introduce visual artifacts, prompting a reference frame retrieval to resynchronize rendering. By offloading frame evaluation and thresholding to the deviation module 245, the spectating renderer can continue to operate with high efficiency.

### Gameplay Services

Gameplay services 254 provide essential backend support for multiplayer gaming, including state synchronization, matchmaking, and player communication. In some embodiments, gameplay services 254 are similar to gameplay services 154 of FIG. 1.

In the context of multiplayer gaming, gameplay services 254 ensure all players connected to game sessions experience a responsive, engaging, and consistent game world through managed network interactions and communication, and by facilitating important environmental and player character state updates. For example, a multiplayer service of gameplay services 154 can be configured to manage the exchange of simulation data between each video game application connected to the game instance, ensuring that each player experiences a consistent game world despite variations in network latency, hardware performance, or input timing.

An authoritative multiplayer game server is a client-server architecture where the centralized server maintains the authoritative state of the game world. Each video game application (i.e., video game client) transmits their local game state to the server, which processes each received state, updates the global game state, and broadcasts the updated state data back to all connected clients. In contrast, non-authoritative game server architecture includes (i) peer-to-peer (P2P) networking where video game applications communicate directly or indirectly through an intermediary game server, and/or (ii) client-hosted synchronization where one designated video game application acts as the host. Instead of a centralized server maintaining the authoritative game state, each video game application independently simulates state and synchronizes the game session state through direct communication with one another. In some embodiments, either the designated host determines the state, or all peers collaboratively determine state, including player movements, physics interactions, and object state changes, by exchanging SSDPs over a network.

Accordingly, when participating in multiplayer gameplay (e.g., in a non-authoritative or authoritative game server), a video game application may be subject to more simulation discrepancies when network performance fluctuations occur, which can result in “corrective” and/or “authoritative” SSDPs to be processed retroactively by a renderer. These reactive and/or delayed simulations may produce notable rendering discrepancies during runtime—this desynchronization issue is commonly known as “rubber banding” to those of ordinary skill in the art. In some embodiments, spectating application 240 and/or spectating service 260 may employ one or more techniques to mitigate these desynchronization issues.

### Spectating Service

In some embodiments, spectating service 260 comprises a game session manager 262 and a streaming module 264. As illustrated in FIG. 2, spectating service 260 integrates both game session manager 262 and streaming module 264 within its architecture. This integration allows for seamless session management and streaming capabilities, enabling multiple spectators to view the same or different gameplay sessions in real-time or asynchronously. In some embodiments, spectating service 260 may further include additional components or functionalities, such as data caching mechanisms, machine learning-based interpolation, or cloud-based scaling, to enhance spectating performance.

The game session manager 262 is configured to manage a list of game sessions available for spectating, including both live and non-live gameplay sessions. The game session manager 262 ensures that game sessions are properly indexed for access by spectating application 240. As would be understood by a person of ordinary skill in the art, this functionality facilitates efficient access to gameplay sessions for spectating purposes.

Additionally, game session manager 262 is configured to store SSDPs corresponding to game sessions it manages and/or indexes, allowing for asynchronous spectating of previous gameplay. In some embodiments, the video game application transmitting SSDPs to spectating service 260 may specify whether SSDPs are to be stored. Furthermore, game session manager 262 can also receive SSDPs from gameplay services 254, thereby expanding its ability to manage, organize, index and/or present game sessions to spectating applications. In some embodiments, SSDPs received from gameplay services 254 can supplement and/or substitute SSDPs received from video game application 230.

In some embodiments, streaming module 264 is responsible for managing the transmission of gameplay data to spectating applications. Streaming module 264 encodes and transmits game state data, including SSDPs and, optionally, audio data, from active game sessions managed by game session manager 262. As would be understood by a person of ordinary skill in the art, streaming module 264 may employ various streaming protocols, compression techniques, and network optimizations to improve transmission efficiency while minimizing latency. Accordingly, in some embodiments, spectating application 240 may include a decoding module to decode any encoded SSDPs received from streaming module 264. Alternatively, in other embodiments, spectating renderer 244 can be configured to receive and use encoded SSDPs for rendering.

In operation, when a spectator requests to view an ongoing game session, game session manager 262 identifies an appropriate session based on predefined criteria, such as session availability, spectator preferences, or game metadata. Streaming module 264 then retrieves and transmits the corresponding SSDPs and audio data to the spectator's computing device, ensuring minimal delay and real-time synchronization.

In some embodiments, spectating service 260 supports multiple concurrent spectators viewing the same or different game sessions. To accommodate high demand conditions, both game session manager 262 and streaming module 264 are implemented with scalable architectures, ensuring robust system performance even when supporting a large number of simultaneous spectating users.

In some embodiments, streaming module 264 is further configured to receive SSDPs corresponding to multiplayer game sessions, distributing SSDPs to spectating applications based on one or more state synchronization techniques, including majority voting consensus, wherein the most frequently occurring SSDP state is selected for rendering; weight-based authority selection, wherein SSDPs from lower-latency peers are prioritized to ensure minimal network lag; and rolling state correction, wherein SSDPs are recalculated based on previous valid states to mitigate state inconsistencies.

To account for network fluctuations and bandwidth constraints, the system implements adaptive transmission policies. In some embodiments, SSDPs are dynamically compressed or down sampled based on available bandwidth. In cases of packet loss or delayed SSDP updates, the spectating application employs client-side extrapolation to infer missing data, thereby ensuring smooth and uninterrupted spectating without necessitating retransmission from the server.

To optimize SSDP transmission, the system applies domain-specific compression schemes, reducing redundancy while prioritizing updates for high-movement game elements. In some embodiments, techniques such as dynamic SSDP fetching adjust the frequency of SSDP requests based on network conditions, while adaptive SSDP compression varies fidelity based on real-time bandwidth availability. For instance, during periods of high network stability, higher-fidelity SSDPs may be transmitted, whereas during network congestion, lower-fidelity SSDPs may be provided.

By way of example, in response to fluctuating network conditions, SSDP data can be dynamically compressed using delta encoding, entropy coding, or variable bitrate streaming techniques. High-priority SSDPs, such as those corresponding to player movements and interactive objects, may be transmitted at full fidelity, while background elements may be down sampled or interpolated locally by the spectating renderer. In some embodiments, if SSDPs arrive late or out of sequence, the spectating application performs rollback interpolation to reconstruct intermediate states from adjacent SSDPs. Furthermore, if an SSDP is missing entirely, the renderer may either extrapolate the missing frame or request a low-fidelity reference frame to maintain visual continuity.

In some embodiments, streaming module 264 is configured to prioritize high-priority SSDPs, such as player positions and physics states, by transmitting them at full fidelity while compressing lower-priority SSDPs, such as background objects and static elements, to reduce data transmission overhead. Additionally, streaming module 264 may dynamically adjust the compression ratio of SSDPs based on real-time network conditions and spectator requirements, ensuring efficient data transmission without degrading core gameplay fidelity.

In some embodiments, spectating application 240 incorporates one or more state synchronization techniques, network adaptation strategies, and predictive rendering mechanisms to ensure visual consistency during spectating. For example, if an SSDP is delayed or lost, spectating application 240 intelligently retrieves the most recent SSDP from an alternate source or applies interpolation techniques to maintain visual consistency. In the context of multiplayer gameplay, one or more video game applications (230) and/or gameplay services (254) may each simulate SSDPs to stream to spectating service 260 and/or spectating application 240. To facilitate smooth spectating for multiplayer gameplay, spectating application 240 and/or spectating service 260 can be configured to dynamically access and compare SSDPs received from multiple participating clients, selecting the most reliable data based on network latency, packet consistency, and server-assisted validation. Discrepancies between received SSDPs are resolved using various techniques, including majority state agreement, weight-based aggregation, and rolling state correction, ensuring that spectating visuals remain smooth and coherent.

By leveraging adaptive state selection, predictive rendering, SSDP redundancy filtering, temporal synchronization, and network-aware optimizations, spectating application 240 and/or spectating service 260 are able to dynamically enhance its rendering performance despite the challenges posed by multiplayer architectures and/or multiplayer SSDP streaming. These techniques ensure that spectators experience a smooth, visually coherent representation of gameplay, even in the presence of network latency, SSDP desynchronization, and/or other inconsistent state simulation updates of the like.

### Spectating Process

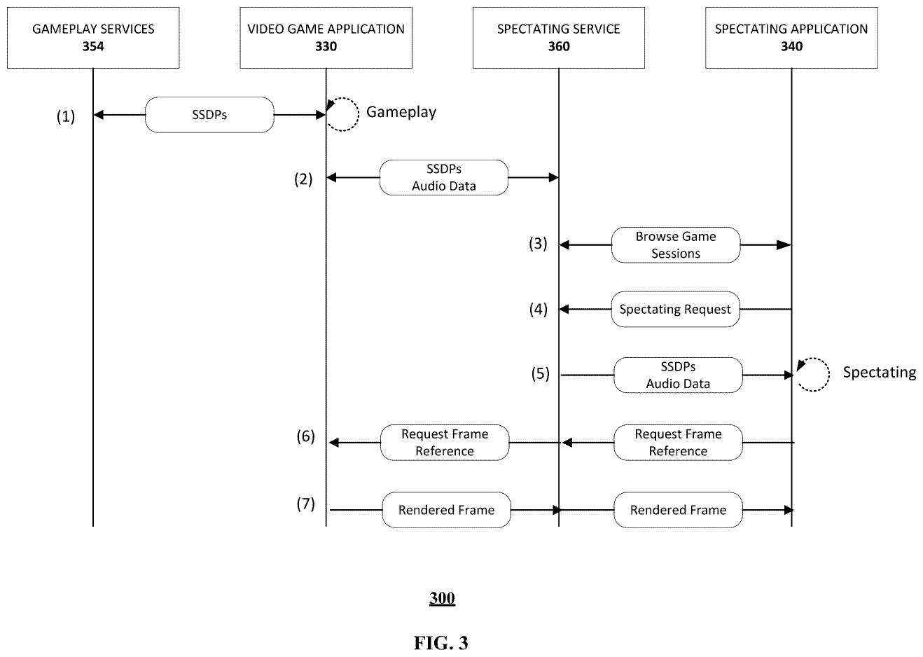

FIG. 3 is a flowchart diagram of SSDP communication for spectating gameplay according to an example embodiment. As shown, FIG. 3 illustrates a flow diagram depicting how game data, such as SSDPs and audio data, are communicated between various components of the system, including gameplay services, a video game application, a spectating service, and a spectating application. Accordingly, diagram 300 details the sequence of interactions that facilitate spectating applications in reconstructing and rendering gameplay frames independently, thereby allowing for state-driven neural rendering rather than conventional pixel-streamed video.

In some embodiments, elements of FIG. 3 correspond to those of FIGS. 1 and 2. For example, gameplay services 354 is similar to gameplay services 154 and 254, which provide functionalities such as multiplayer synchronization, authoritative game state validation, and data exchange between connected players. Video game application 330 is similar to video game applications 130 and 230, handling the simulation of gameplay, the generation of SSDPs, and the transmission of state data to other components of the system. Spectating service 360 is similar to spectating service 160 and 260, acting as an intermediary that facilitates state streaming between video game applications and spectating clients. Spectating application 340 is similar to spectating applications 140 and 240, wherein gameplay frames are reconstructed and rendered based on the received SSDPs from the spectating service. In some embodiments, diagram 300 also corresponds to the transmissions and/or streaming of game data other than SSDPs, audio data, and reference frame data.
At step (1), video game application 330 begins gameplay. In some embodiments, the simulation engine of video game application 330 produces SSDPs during gameplay, which become available for rendering and/or external transmission. Simultaneously, the video game application generates corresponding audio data, which also becomes available for rendering and/or external transmission. The audio data includes in-game sounds, character dialogue, and ambient sound and music, among other things. The SSDPs and audio data can be transmitted to gameplay services 354, spectating service 360 and/or spectating application 340.

Accordingly, over the course of gameplay (e.g., step 1), gameplay services 354 receive SSDPs from video game application 330, among other things. In some embodiments, gameplay services 354 function to synchronize SSDPs across multiple video game applications to ensure that all instances of the multiplayer game session provide and/or receive a consistent and/or unified game state. In single-player gaming scenarios, gameplay services 354 may act as a relay, facilitating state data transmission for external services such as the spectating service 360, and/or as a data store for SSDPs.
At step (2), video game application 330 streams data corresponding to gameplay—including SSDPs and audio data, among other things-to spectating service 360. Among step 2, spectating service 360 can store the streamed data received from video game application 330 to one or more data stores, and/or make the corresponding gameplay session available for browsing, viewing, and/or spectating by spectating application 340. In some embodiments, video game application 330 also provides and/or streams reference frames for spectating service to associated, and store in conjunction with, SSDPs. Accordingly, these stored reference frames may be used by spectating applications when spectating a
At step (3), spectating application 340 accesses spectating service to view and/or browse game sessions available for spectating. Spectating service 360 present both live and/or previous game sessions to spectating application 340.
At step (4), spectating application 340 initiates a spectating request to the spectating service 360. In some embodiments, this request may specify a particular gameplay session to spectate. The request may include one or more data streams—audio, SSDPs—for the spectating application to receive. Upon receiving the request, spectating service 360 identifies the corresponding game session and transmits the relevant data streams—one or more SSDPs and audio data from either the video game application 330 and/or gameplay services 354. In some embodiments, the SSDPs and/or audio can be streamed directly from video game application 330. In alternative embodiments, the SSDPs and/or audio can be streamed indirectly from video game application 330 through spectating service 360 and/or gameplay services 354. In other embodiments, one or more data streams is received from each the gameplay services 354, video game application 330, and/or spectating service 360.
At step (5), in response to a spectating request, one or more streams of SSDPs and audio data for a selected game session are transmitted spectating application 340 by spectating service 360. Upon receiving the data streams—of SSDPs and audio data—spectating application 340 processes the data streams to reconstruct gameplay visuals. In some embodiments, the audio stream is transmitted in a separate stream from the SSDPs is synchronized with the rendered visuals to ensure accurate playback. In other embodiments, audio data is transmitted over the same data stream.
During step 5, a spectating renderer within spectating application 340 applies, during the rendering providing a spectating view of the gameplay, one or more rendering optimizations including state interpolation to smooth transitions between SSDPs, predictive rendering to compensate for missing or delayed SSDPs, and/or adaptive resolution scaling to match available computational resources of a respective computing device, and/or to account for fluctuating network conditions. Once the game state data is processed and rendered, the spectator is able to view and interact with the spectated gameplay. The spectating application may further allow users to modify rendering parameters to apply visual modifications including changing camera angles, following different players, adjusting lighting conditions, or altering terrain attributes. In some embodiments, these modifications are applied locally within the spectating application and do not alter the rendered view of video game application 330. However, when the applied modifications result in a deviation exceeding a predefined threshold, the spectating application may issue a request for a reference frame from video game application 330.
At step (6), the spectating application 340 sends a reference frame request to the spectating service 360. In some embodiments, the request is triggered when a frame evaluator module (e.g., 245 of FIG. 2) detects that the rendered frame has deviated beyond an acceptable threshold relative to the expected SSDP-based rendering. The reference frame request is forwarded by spectating service 360 to video game application 330, which can then transmit a fully rendered reference frame. In some embodiments, a reference frame may be requested when SSDP-based rendering alone is insufficient to maintain high visual fidelity, such as when significant modifications have been applied to the rendering environment by the spectator, when network latency fluctuations introduce inconsistencies in SSDP transmission, or when large-scale camera transitions cause unintended visual artifacts.
At step (7), the video game application 330 generates and transmits a fully rendered reference frame to spectating service 360, which then delivers it to spectating application 340. In some embodiments, the reference frame is integrated into the spectating renderer to correct any accumulated rendering drift, ensuring that the displayed visuals remain consistent with the game's intended visual output. The reference frame provides a validated snapshot of the game state at a specific moment, allowing the spectating renderer to correct any discrepancies that have developed over time. Once the reference frame is applied, the spectating application continues rendering gameplay using SSDPs, with subsequent reference frames requested only as needed based on deviation thresholds. The combination of SSDP-driven rendering and periodic reference frame validation enables the spectating application to maintain high visual fidelity while minimizing bandwidth consumption.

Accordingly, a reference frame serves as a recalibration mechanism, allowing the spectating application to realign its rendering with the original game engine output. Therefore, the reference frames do not serve as the main basis for spectating gameplay among a spectating application. In some embodiments, reference frames are not presented to the spectating viewer.

Through the process illustrated in FIG. 3, spectating application 340 is able to dynamically reconstruct gameplay visuals without requiring a complete game installation or high-bandwidth video streaming. The system enables an interactive and efficient spectating experience by leveraging SSDPs for state-driven rendering while allowing real-time modifications and rendering optimizations. The integration of reference frame requests further enhances the robustness of the spectating system by ensuring that rendering fidelity is maintained even under variable network conditions or extensive user modifications. By decoupling state-driven rendering from the traditional game engine rendering pipeline, the described approach reduces computational and network overhead while providing an interactive and immersive spectating environment.

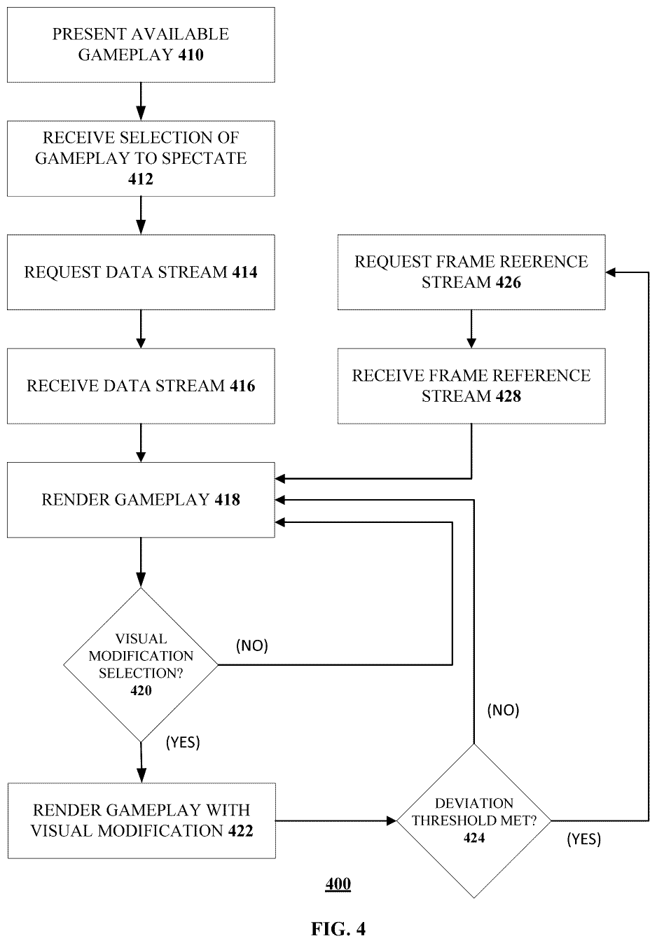

FIG. 4 is a process diagram of rendering gameplay from SSDPs according to an example embodiment. FIG. 4 illustrates diagram 400 depicting the process corresponding to a spectating application configured to stream and render gameplay based on SSDs received from a video game application and/or spectating service.
At step (410), the spectating application presents a list of available gameplay sessions that a spectator user may spectate among a spectating application. In some embodiments, the available gameplay sessions may include live multiplayer matches, single-player sessions, or previously recorded gameplay replays. The available game sessions for spectating may be retrieved from a spectating service, which maintains an index of active and recorded game instances. The system may also provide filtering options that allow users to view filtered and/or preferable games, events, or matches based on one or more preferences or settings.
At step (412), the spectating application receives the user's selection of a gameplay session to spectate. In some embodiments, the selected session may correspond to an ongoing game session or a replay of a previously recorded game session.
At step (414), the spectating application sends a request to spectate the selected game session to a spectating service. In some embodiments, this request includes a request for spectating service to initiate a data stream of the indexed data corresponding to the selected game session. In other embodiments, this request specifies can also include rendering preferences and target resolution for the spectating experience, so as to inform the spectating service of the fidelity at which provide a data stream in.
At step (416), the spectating application begins receiving the data stream from the spectating service. The data stream includes SSDPs containing game state data necessary for rendering the gameplay, as well as an accompanying audio stream corresponding to in-game sounds, character dialogue, and other audio elements.
At step (418), the spectating application processes the received SSDPs to reconstruct the game scene and synchronize the visual rendering with the received audio data to render a spectating view of the game session's gameplay. In some embodiments, interpolation techniques are applied to ensure smooth transitions between SSDPs, particularly when the rate at which SSDPs are received differs from a preferred and/or target rendering frame rate of the spectating application. In some embodiments, the rendering process may also involve adaptive resolution scaling to accommodate variations in network conditions or computational resources.
At step (420), the system determines whether the user has selected to apply any visual modifications to the rendered gameplay. If the spectator has not selected any modifications (the “No” branch), the process continues rendering gameplay as received from the data stream, looping back to step (418) to ensure continuous playback. If the spectator applies one or more visual modifications (the “Yes” branch), the process proceeds to step (422).
At step (422), the spectating application renders gameplay with visual modifications applied by the spectator. In some embodiments, the spectator may select to apply visual modifications to gameplay by adjusting and/or changing elements such as lighting conditions, terrain textures, environmental effects, or applying visual changes of the like. Additionally, the spectator may manipulate the camera view dynamically, enabling free camera movement or switching between different perspectives. These visual modification are rendered in real-time, providing an interactive spectating experience among the spectating application.
At step (424), the spectating application evaluates whether the rendering deviation has exceeded a predefined threshold. The deviation threshold is managed by a frame evaluator module, which continuously monitors rendering consistency of rendered frames in comparison to an estimated reference frame, such as by analyzing pixel deviation, environmental inconsistencies, and other discrepancies that may arise from user modifications and/or network fluctuations. If the deviation remains within acceptable limits (the “No” branch), the process returns to step (418), where gameplay continues to be rendered based on the SSDPs while maintaining user modifications. If the deviation exceeds the predefined threshold (the “Yes” branch), the system proceeds to step (426) to request a reference frame.
At step (426), the spectating application sends a reference frame stream request to the spectating service. In some embodiments, this request is triggered when SSDP-based rendering alone is insufficient to maintain accuracy, such as in cases where significant user-driven modifications have substantially altered the rendering environment and/or when network conditions have caused discrepancies and/or in consistencies in streamed SSDPs. The reference frame request prompts the spectating service to retrieve and transmit a fully rendered frame from the video game application.
At step (428), the spectating application receives the reference frame stream from the spectating service. The reference frame consists of a complete, fully rendered game frame generated by the original game engine, which is then used to realign the spectating renderer and correct any accumulated rendering drift. The received reference frame is analyzed by a spectating renderer of the spectating application and recalibrates rendered frames if necessary. Following this, the process loops back to step (418), where the spectating application resumes rendering the gameplay with the recalibrated visuals.

Through the process illustrated in FIG. 4, the spectating application dynamically adapts to received game state data while allowing real-time modifications by the user. By leveraging SSDP-based rendering, the system provides a low-bandwidth alternative to traditional video-based spectating while maintaining high visual fidelity through the integration of reference frame requests when necessary. The combination of interactive rendering modifications and real-time deviation evaluation ensures a flexible and immersive spectating experience that remains consistent with the original gameplay state. For instance, Spectators can modify rendering parameters without altering SSDPs received from the game engine. Instead, modifications are applied at the spectating renderer level, enabling adjustments such as real-time lighting changes, terrain swaps, and environmental effects without interfering with the underlying simulation.

The steps and process of FIG. 3 and FIG. 4 can be associated with one or more hardware and/or software modules configured with computer-executable instructions. A person of ordinary skill in the art would recognize and appreciate how the proceeding process may be configured in many ways, such that one or more of steps are performed before, after, or simultaneously among other steps, and/or otherwise omitted or substituted in whole or in part.

### Spectating Renderer

A neural renderer of a spectating application can comprise or include one or more neural networks (e.g., machine learning models) configured to render gameplay for spectating. Accordingly, the neural renderer is trained and/or configured to render the visual content of video game application, in whole or in part. For example, one or more neural networks among the neural renderer of a spectating application can each be trained and/or configured to perform one or more rendering techniques such as caching, compression, lighting, upscaling, and rasterization, among other things. The combination of these neural networks can work conjunction with one another to comprise and/or supplement a rendering pipeline for rendering frames of gameplay. As known to a person of ordinary skill in the art, a “mixture-of-experts” network is a common technique for a combination of neural networks to be used in conjunction with one another to form a broader pipeline.

In some embodiments, games of different genres have SSDP structures that differ from one another to account for different environmental, object, or player characters parameters, attributes, and/or characteristics. For example, Real-time strategy (RTS) games may have different SSDP structures than sports game. Additionally, games of the same genre may also vary in graphical styles, color palettes, designs, mechanics, logic, and other aspects, which can also contribute to how SSDPs differ. Accordingly, each video game may require a different, and specifically trained, neural renderer to render gameplay.

In some instances, where two video game applications do produce similar SSDPs-such as those that have similar game engines and/or game data then a single neural render can be configured to render both of those games. For example, if an automotive racing video game franchise releases a first and second iteration of a video game, then one neural render can be used to render the SSDPs of both games, so long as they remain similar enough to another.

However, as one of ordinary skill in the art would appreciate, a neural renderer will be to infer closest associates with unfamiliar data inputs. Accordingly, as iterations of a game change more substantially, it would become necessary to update and/or retrain the neural render to account for how SSDPs have changed in addition to retraining it on new ground truth images for any new visual content (e.g., objects, environments, player characters, and other assets of the like) have also changed. Likewise, because many modern games include “live services”, in which new “versions” of a game are released with new and/or updated visual content and SSDP data, then a neural renderer for that game would also require an update and/or retraining for it to appropriately render the new visual content. The retraining of a neural renderer for a video game, can, therefore, learn new associations between ground truth frames of new visual content and SSDPs (include known SSDPs and/or new SSDPs).

As such, a spectating application is also configured install and/or update neural renderers for each video game application is configured to update, from which the spectating application can source, received, request, and/or download from a spectating service. For example, the spectating application can include installations and/or updates to one or more neural renderers, each of which can correspond to a video game application and/or a version of a video game application that a user (e.g., spectator) of the spectating application has spectated, or has selected to spectated.

Accordingly, as users choose to spectate new video game applications (e.g., that they previously did not spectate) and/or recently updated video game applications (e.g., updated with new visual content not previously accounted for during the training of a neural renderer), the spectating application can download a corresponding neural renderer or neural renderer update from a spectating service.

Furthermore, because a neural render trained association between ground truth images and SSDPs, it can render frames in different quality than that of the source video game application. For example, if a video game application is streaming its SSDPs for spectating, the graphical quality settings set among that particular video game application do not apply to graphical quality that spectating application will render the SSDPs at. Accordingly, if a neural renderer is trained on ground truth images that correspond to the high visual fidelity of a video game application, then the neural renderer will render frames at that high visual fidelity, even if it is receiving a stream of SSDPs from a video game application that is set low visual fidelity.

Additionally, this also benefits different platform versions of the video game, which are made for different and/or particular computing devices. For instance, a version of a video game made for smartphone device is generally configured with lower visual quality, but if it has a video game console counterpart version that includes higher visual fidelity, the neural render can be trained off of ground truth images from the video game console version so that when the a player of smartphone version makes their gameplay available for spectating, the spectating application will render frames of gameplay in a higher visual fidelity.

Alternatively, lower visual fidelity versions of the model that run more efficiently on computing devices can be made available for spectating applications to download, thereby enabling computing devices with fewer and/or limited computing resources to also spectate the gameplay. In some embodiments, a neural renderer is configured with multiple neural rendering models at differing visual fidelity levels and can dynamically and/or adaptively select the best visual fidelity model to use during rendering based on computing resources and/or network conditions. For example, if GPU resources are constrained, lower-complexity models are used.

Accordingly, a spectating application can download one or more neural renderers, each of which can be configured for a particular video game application and/or version of a video game application. In some embodiments, more than one neural render can be configured for a video game application and/or video game application version, such as per visual fidelity level. Alternatively, in some embodiments, a neural renderer for a video game application can include, among its MoE architecture, multiple expert networks that, alone or in a subset, correspond to outputting rendered frames in a particular visual fidelity level.

In some embodiments, one or more of the networks within the neural renderer can be configured to perform procedural generation rather than a reconstructive generation. For example, using procedural generation to produce high detailed texture maps can be used in place of standard reconstruction generation. For example, procedural generation can be beneficial for producing high resolution textures for one or more virtual object and/or virtual characters among a rendered frame.

### Training

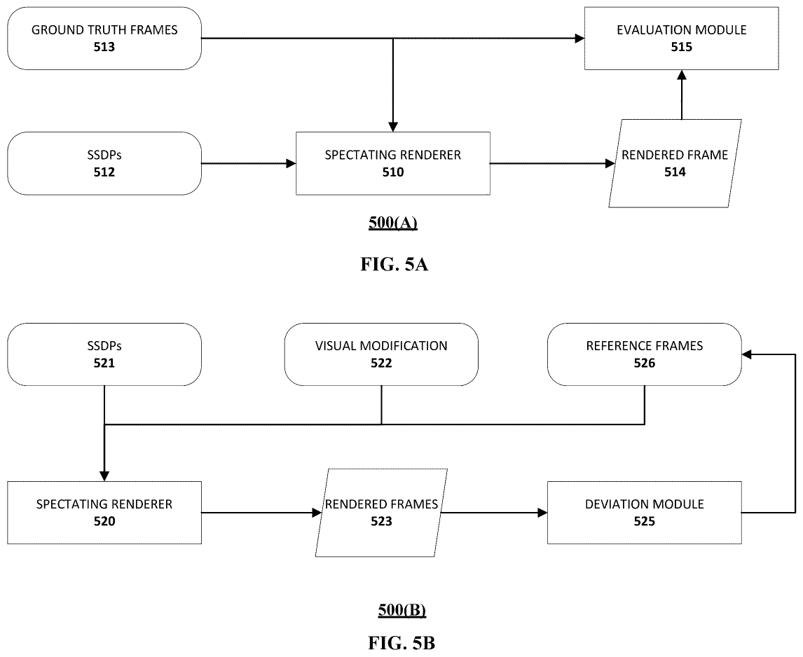

FIG. 5A is a system diagram of configuring a renderer for spectating gameplay according to an example embodiment. As shown, system 500(A) illustrates a system diagram of the training architecture of the spectating renderer 510. In some embodiments, spectating renderer includes a number of neural networks trained and/or configured for rendering gameplay based in part on SSDPs. The neural renderer is trained using a dataset of game states (SSDPs) and corresponding ground truth frames 513.

A generative adversarial network (GAN) architecture is used during training, such that the spectating renderer (510) learns to render visuals from SSDPs, and the discriminator (or evaluation module) (515) evaluates accuracy of rendered frames 514 against ground-truth renders (or ground truth frames) 513 and provides recalibrations for spectating renderer 510 accordingly. In some embodiments, the model is further refined using reinforcement learning techniques, optimizing rendering quality while maintaining low computational costs.

For example, a spectating renderer can be implemented as a mixture-of-experts (MoE) architecture that includes multiple specialized rendering models. Trained using a generative adversarial network (GAN) framework, it uses the evaluation module 515 as the discriminator network to compare rendered frames 514 against ground truth frames 513, iteratively refining the model for high-fidelity visuals from SSDPs 512. This system enables spectating applications to generate high-quality gameplay visuals dynamically, reducing reliance on full game assets or high-bandwidth video streaming.

In the MoE structure, each rendering model specializes in tasks such as lighting reconstruction, texture synthesis, anti-aliasing, shading, motion blur compensation, and upscaling. The renderer processes SSDPs 512, which encapsulate game state information including object positions, animations, and environmental effects, to reconstruct game visuals in real-time. SSDPs used for training are captured from gameplay sessions, ensuring the model learns associations with ground truth frames 513, improving generalization across different graphical fidelities.

Rendered frames 514 produced by the spectating renderer 510 are evaluated by the evaluation module 515, assessing visual discrepancies, texture coherence, lighting accuracy, and motion smoothness. This module uses metrics like structural similarity index (SSIM), mean squared error (MSE), perceptual loss functions, and adversarial loss to ensure the generated visuals match actual game frames closely. The optimization techniques include loss function refinement, feature enhancement learning, temporal stability analysis, and adaptive expert selection.

Working iteratively, the renderer generates frames, the discriminator evaluates them for quality, and corrections are applied to enhance the model's visual synthesis capability from SSDPs. This adversarial training continues until the renderer achieves the desired accuracy, ensuring efficient real-time operation. The GAN-based training pipeline enables the spectating renderer to offer high-fidelity, low-bandwidth game visualizations, supporting interactive features like real-time modifications and dynamic camera perspectives while maintaining efficient rendering workflows.

Overall, the spectating renderer 510 evolves into an adaptive, high-performance rendering system capable of generating photorealistic gameplay visuals from SSDP data through temporal interpolation, texture generation, and learned scene reconstruction techniques, without needing raw game assets.

In addition, spectating renderer 510 can be configured to synchronize audio data streams with the frames it renders by leveraging corresponding audio state data embedded within the Simulation State Data Packets (SSDPs). Each SSDP may include timestamps, spatial audio metadata, and event-triggered sound cues that align with the game's state at a given moment. The renderer can process these timestamps to ensure that audio playback is dynamically adjusted to match the rendering of frames, even when SSDPs are interpolated for smoother motion. In cases where network latency or dropped packets cause desynchronization, the renderer may apply predictive buffering and time-stretching techniques to maintain synchronization without noticeable distortion. Additionally, if a reference frame is requested due to rendering drift, the spectating application can realign the audio playback based on the most recent game state, ensuring that environmental sounds, dialogue, and effects remain accurately positioned and temporally coherent with the spectated gameplay.

Additionally, during the training and/or configuration process, the spectating renderer 510 is further configured to periodically generate an estimated reference frame to maintain rendering accuracy and visual coherence. This estimated reference frame is derived from SSDPs received and serves as a predictive reconstruction of the game state as viewed by a player of a video game application. By continuously generating estimated reference frames, the spectating renderer 510 ensures that deviations between interpolated frames and actual gameplay states remain within acceptable thresholds.

Moreover, the periodic generation of estimated reference frames enhances the spectating renderer's ability to apply adaptive interpolation techniques. For example, in some embodiments, the renderer uses estimated reference frames to supplement the render frame rate when either missing and/or receiving delayed SSDPs. As such, estimated reference frames can also be used to optimize the spectating experience by reducing the reliance on high-bandwidth reference frame requests while maintaining high-fidelity rendering of the spectated gameplay.

### Inference

FIG. 5B illustrates the system 500(B) of a trained spectating renderer 520 of a spectating application. As shown, spectating renderer 520 is configured to generate rendered frames 523 based at least in part on SSDPs 521, visual modifications 522, and, when applicable, reference frames 526.

During runtime of a spectating application, spectating renderer 520 receives SSDPs 521 from a video game application. These SSDPs 521 provide the necessary data for reconstructing gameplay visuals without requiring full game assets or high-bandwidth video streaming. The spectating renderer 520 dynamically generates frames 523 using these SSDPs 521 and applies user-selected visual modifications 522 to alter the spectated gameplay experience.

The spectating renderer 520 is also configured to render estimated reference frames, which are periodically generated to serve as a baseline for deviation module 525 to evaluate rendering accuracy of rendered frames 523. These estimated reference frames are constructed from SSDPs 521 and provide a predictive reconstruction of the game state at a given moment. By continuously generating estimated reference frames, the spectating renderer 520 ensures that deviations between interpolated frames and actual gameplay states remain within acceptable thresholds, mitigating visual discrepancies that may arise from interpolation errors, network fluctuations, or user-applied modifications 522. Estimated reference frames allow the renderer to detect rendering drift early, reducing the need for frequent reference frame requests while maintaining visual fidelity.

In some embodiments, rendered frames 523 consist of both frames with visual modifications 522 applied and estimated reference frames. Frames with visual modifications 522 reflect the user-selected alterations, such as changes to lighting, textures, environmental effects, or camera angles, applied at the renderer level without altering the underlying game state. Estimated reference frames, in contrast, function as a dynamically updating baseline that—by way of deviation module 525—allow a spectating application to ensure that the rendered output remains consistent with expected gameplay visuals.

The deviation module 525 evaluates rendered frames 523, including estimated reference frames, to determine whether the reconstructed visuals remain within an acceptable threshold of accuracy. This module analyzes pixel deviation, object positioning errors, lighting discrepancies, and animation smoothness to detect rendering inconsistencies. If the deviation between an estimated reference frame and the rendered output exceeds a predefined threshold, the deviation module 525 triggers a request for a full reference frame 526 from the corresponding video game application. This process ensures that the spectating renderer 520 recalibrates periodically to maintain visual accuracy while minimizing the reliance on high-bandwidth reference frame requests when rendered frames 523 of spectating gameplay are applying visual modifications 522.

Reference frames 526 provide authoritative visual snapshots of the game state and are obtained directly from the game engine when needed. These reference frames 526 are requested by the deviation module 525 only when rendering drift exceeds acceptable limits, ensuring that they serve as occasional recalibrations rather than the primary rendering source. Once a reference frame 526 is received, the spectating renderer 520 realigns its output to match 526. By balancing SSDP-driven rendering with estimated reference frame validation and selective reference frame retrieval, the spectating renderer 520 maintains high efficiency, customization, and fidelity without incurring unnecessary bandwidth costs.

### Examples

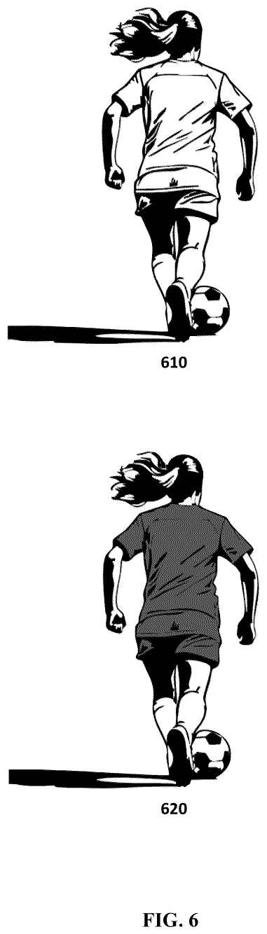

FIG. 6 illustrates of a first rendering example according to an example embodiment. As illustrative and non-limiting examples, image 610 is a frame rendered by a renderer of game engine of a video game application and image 620 is a frame rendered by a renderer of spectating application-such as video game application 230 and spectating application 240 shown in FIG. 2. As shown, the frames 610 and 620 are similar to one another, and are rendered based at least in part on the same and/or similar SSDPs. Accordingly frame 610 can be a first rendered view of gameplay, while frame 620 can be a second rendered view of the same gameplay.

Frame 610 illustrates gameplay of a soccer video game where a player character has long hair tied back in a ponytail and is wearing a white jersey consisting of a short-sleeved shirt, shorts, and knee-high socks, is depicted from behind running with a soccer ball at their feet. The state of the player character and ball shown in can each correspond to one or more SSDPs that are generated by a simulator and streamed to a stream layer to be accessed for rendering by a renderer of the video game.

A spectating application can also receive the SSDPs generated by the simulator to also render frame 610, as shown. Alternatively, the spectating application can also present a graphical user interface that enables user interaction and user input for making a selection of one or more visual element modifications to make to frame 610. For example, spectating application can present selections corresponding to changing the color of a virtual object, such as the player character's jersey clothing.

Accordingly, frame 620 is rendered by a spectating application based in part on the SSDPs used to render frame 610—which are streamed to it—and user input corresponding a visual element modification of the jersey of the player character to be of a different color. As shown, frame 620 is similar to frame 610, but shows the player character wearing a black jersey instead of a white one.

In turn, frame 610 can correspond to the frame rendered to display to a video game application, while frame 620 can correspond to the frame rendered to display by a spectating application, based on part of the SSDPs used to generate frame 610 in addition to user input for modifying one or more visual elements.

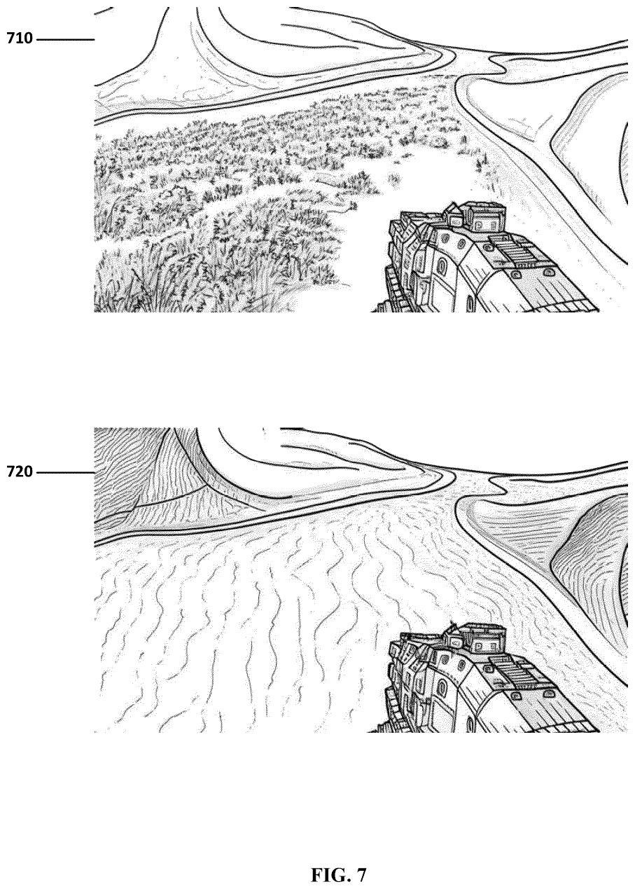

FIG. 7 illustrates a second rendering example according to an example embodiment. As illustrative and non-limiting examples, image 710 is a frame rendered by a renderer of a game engine in a video game application, while image 720 is a frame rendered by a renderer of a spectating application—such as video game application 230 and spectating application 240 in FIG. 2. As shown, frames 710 and 720 are similar to one another, but exhibit different terrain characteristics while being rendered based at least in part on the same and/or similar SSDPs. Accordingly, in some embodiments, frame 710 can be a first rendered view of gameplay, while frame 720 can be a second rendered view of the same gameplay.

Frame 710 illustrates gameplay of a first-person video game in which the player's perspective is directed towards an open landscape featuring light foliage, such as grass and shrubs, in a valley setting. The in—game rendering engine generates frame 710 based on game data, where the terrain attributes-including vegetation, texture, and surface properties—are rendered based in part on one or more SSDPs generated by the game engine's simulator.

A spectating application can also receive the SSDPs used to generate frame 710, enabling real-time, near real-time, and/or asynchronous rendering of the same gameplay instance. The spectating application further presents an interface that allows for interactive modification of environmental attributes before or during rendering. In this example, a user has selected to modify the terrain characteristics, replacing the light foliage with a sandy, dune-like landscape.

Accordingly, frame 720 is rendered by a spectating application based in part on the SSDPs used to render frame 710, in addition to user input that modifies the terrain. As shown, frame 720 maintains the same structural elements—such as the position and orientation of the weapon in the foreground and the surrounding topographical features—while applying different terrain textures and surface conditions, altering the environment to resemble a desert landscape instead of a grassy valley.

In turn, frame 710 corresponds to the rendering generated within the video game application, while frame 720 corresponds to the rendering displayed by the spectating application, wherein selected visual element modifications have been applied to the terrain.

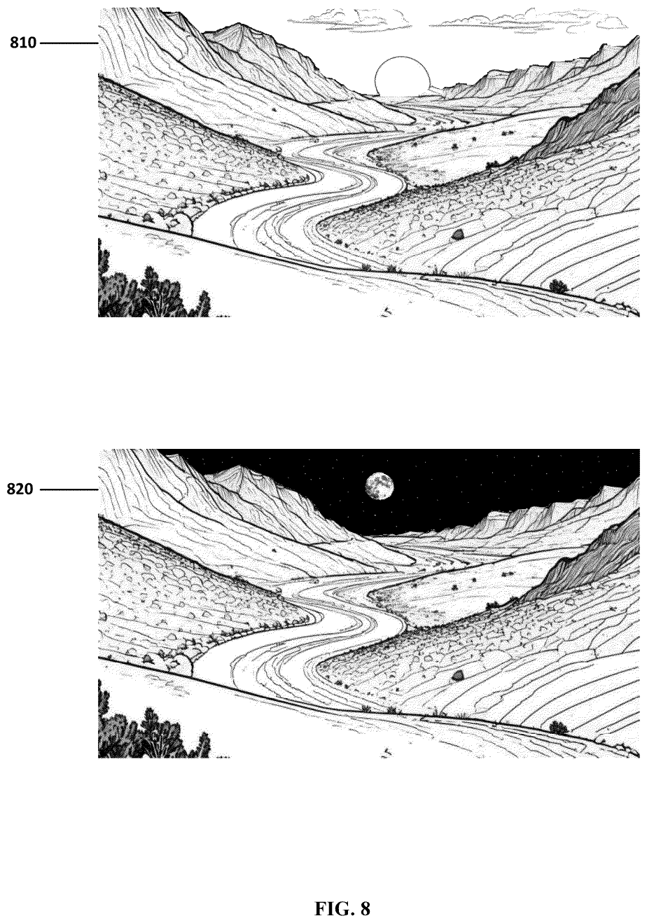

FIG. 8 illustrates a third rendering example according to an example embodiment. As illustrative and non-limiting examples, image 810 is a frame rendered by a renderer of a game engine in a video game application, while image 820 is a frame rendered by a renderer of a spectating application—such as video game application 230 and spectating application 240 in FIG. 2. As shown, frames 810 and 820 depict the same landscape, but with different lighting and atmospheric conditions while being rendered based at least in part on the same and/or similar SSDPs. Accordingly, in some embodiments, frame 810 can be a first rendered view of gameplay, while frame 820 can be a second rendered view of the same gameplay.

Frame 810 illustrates gameplay of a first-person video game where the player is observing a vast rocky landscape at dawn. The terrain includes rolling hills and rugged mountain formations, with scattered vegetation throughout. The in-game rendering engine generates frame 810 based on simulation data, with lighting, shadows, and atmospheric elements corresponding to a time-of-day setting within the game world. These lighting conditions and environmental attributes are determined using SSDPs generated by the simulation engine, which encode parameters such as sky color, light direction, terrain shading, and ambient occlusion effects.

A spectating application can also receive the SSDPs used to generate frame 810, enabling real-time rendering of the same gameplay instance. The spectating application further presents an interface that allows users to modify environmental variables dynamically. In this example, a user has selected to adjust the time of day from dawn to nighttime, altering the scene's lighting, sky appearance, and overall atmosphere.

Accordingly, frame 820 is rendered by a spectating application based in part on the SSDPs used to render frame 810, in addition to user input modifying the scene's lighting conditions. As shown, frame 820 maintains the same structural landscape—retaining the placement of mountains, hills, and vegetation—while altering the illumination to reflect a nighttime environment. The sky has transitioned from a bright dawn setting to a dark, star-filled night, with the moon providing primary illumination in the scene. Shadows and terrain highlights are adjusted accordingly, showcasing how user-driven modifications can dynamically change environmental conditions in a spectated view.

In turn, frame 810 corresponds to the rendering generated within the video game application, while frame 820 corresponds to the rendering displayed by the spectating application, where user-defined modifications to the time of day have been applied. This example highlights how a spectating application, utilizing streamed SSDPs, allows for interactive customization of lighting and time-dependent visual elements without altering the underlying game simulation.

FIGS. 6, 7, and 8 illustrates how a spectating application, leveraging streamed SSDPs, can allow users to customize the visual appearance of a game environment without modifying the underlying game simulation. In some embodiments, the illustrated frame pairs 610 and 620, 710 and 720, and 810 and 820 are rendered based in part on similar SSDPs, such that (i) one of the frames is rendered with a subset of the SSDPs the other is rendered with, or (ii) one of the frames is rendered with a set of SSDPs that are similar, but not identical SSDPs. For example, a subset of the SSDPs used for frame 610 can be used to generate from 620 when receiving down sampled SSDPs from a spectating service, or when a spectating application interpolates SSDP data to increase frame rate.

### Computing Device

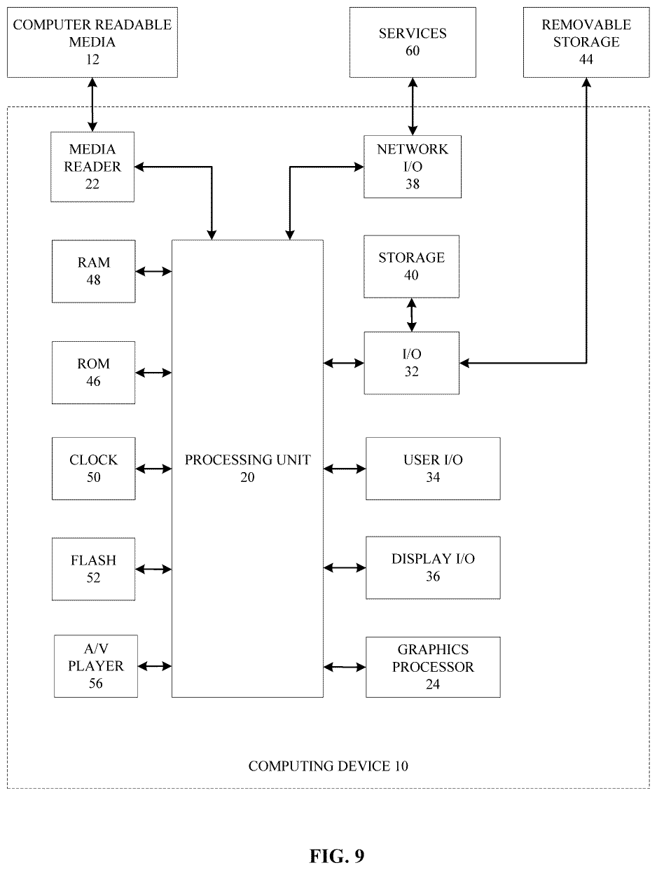

FIG. 9 illustrates an example embodiment of a computing device 10. In some embodiments, some or all of the aforementioned systems and computing devices—such as computing device 110 and 120 of FIG. 1—a re similar to computing device 10. The example computing device 10 can store and/or execute computer executable instructions (or code) of applications (or programs or software), such as video game applications, interactive applications, and/or other applications known to those of skill in the art that could include or benefit from the systems and methods described herein.

Computing device 10 can be or include any one or a combination of systems known to those of skill in the art, including, for example, a desktop, laptop, game application platform, game console, virtual reality system, augmented reality system, television set-top box, television, network-enabled kiosk, car-console devices, computerized appliance, wearable device (e.g., smart watch, glasses with computing functionality), and wireless mobile devices (e.g., smart phones, PDAs, tablets) and other general-purpose computing devices known to those of skill in the art.

As shown, computing device 10 includes processing unit 20 that interacts with other components of the computing device 10 and external components. A media reader 22 communicates with computer readable media 12. The media reader 22 may be an optical disc reader capable of reading optical discs, such as DVDs or Blu Ray discs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system for executing software among graphics processor 24, such as a video game application.

Computing device 10 also includes various components for enabling input/output, such as an I/O 32, a user I/O 34, a display I/O 36, and a network I/O 38. I/O 32 interacts with storage element 40 and removable storage media 44 to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network (e.g., receiving and sending network data communications). Network I/O 38 may be used during execution of software applications by computing device 10; such as when a video game application communicates with a game server over a network.

Display output signals produced by processing unit 20 and/or graphics processor 24 can be sent to display by display I/O 36, including signals for displaying visual content produced by computing device 10; such as display output rendered by a video game application, including graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other features, such as a clock 50, flash memory 52, and other components. An audio/video player 56 might also be used to play a video sequence, such as a movie or other media as known to those of ordinary skill in the art. An audio/video player 56 may include or use software for encoding or decoding media for playback.

Computer executable instructions, applications, programs, or code (e.g., software) can be stored in ROM 46, RAM 48, media 12, and/or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, applications can be found embodied in a tangible non-transitory signal-bearing medium.

Random access memory (RAM) 48 (and possibly other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, services 60 accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

The disclosed subject matter can include an apparatus for performing the operations herein. This apparatus may be specially constructed for the required purposes, or it may comprise a general-purpose computer selectively activated or reconfigured by an application stored and/or executed by computing device 10. Such an application may be stored in a non-transitory computer readable medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The disclosed subject matter may include a non-transitory computer readable medium having stored thereon applications or instructions, which may be used (e.g., executed) to instruct a system or computing devices to perform a process according to the disclosed subject matter. A non-transitory computer readable medium includes any mechanism for storing or transmitting information in a form readable by a computing device and other systems of the like known to those of skill in the art.

The applications or instructions of computing device 10 can be stored and/or executed among a local environment and/or among in a distributed environment of computing devices, as known to those of skill in the art. Different applications can include varying instructions, components, graphical configurations, and/or data for supporting their runtime execution on different hardware (e.g., different types of computing devices).

A locally executed application does not rely on or use an external computing device (e.g., a system other than computing device 10) to execute the application. In some instances, a locally executable video game application can communicate with external systems or devices, such as external servers, to retrieve information associated with the video game, such as game patches, game authentication, cloud saves, user account data, previously trained model data, or other features.

In distributed implementations, computing device 10 may execute portions of a video game application, while other systems or devices such as external servers execute other portions of the video game application. For instance, massively multiplayer online role-playing games (MMORPGs) include client portions (e.g., video game application) of the video game executed by computing devices of or corresponding to users or players, and server portions executed by one or more servers. It should be understood that applications described herein can be a locally executable game or a distributed application.

Graphics processor 24, or graphics processing unit (GPU), can perform processing tasks associated with rendering images, graphics, and visual content, in addition to machine learning tasks. A GPU commonly comprises multiple processing cores that execute operations in parallel, optimizing performance for tasks such as 3D rendering, texture mapping, shading, and real-time physics simulations. In addition to dedicated rasterization units, shading engines, and ray-tracing cores, a GPU may include high-bandwidth memory (VRAM) and support for general-purpose computing, enabling it to handle computational workloads beyond graphics, including scientific simulations, cryptography, and machine learning and/or neural network processing. GPUs can operate as discrete hardware components or as integrated units within system-on-chip (SoC) architectures, often interfacing with CPUs, memory controllers, and high-speed interconnects for efficient data processing.

As known to a person of ordinary skill in the art, modern GPUs increasingly incorporate dedicated machine learning hardware, such as tensor cores, matrix multiplication units, and neural processing units (NPUs), which accelerate deep learning inference, neural network training, and AI-driven rendering techniques. These specialized components enhance real-time upscaling, denoising, adaptive shading, as well as neural-based image, frame, video, and audio reconstruction, among other things, allowing for more efficient and high-fidelity visual output. Accordingly, it is appreciated that GPUs can be configured to enable the execution of neural rendering models, physics-based simulations, and real-time generative AI applications, in addition to the systems and methods described herein.

The present disclosure may use machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

The present disclosure may use deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (e.g., classes or techniques) of machine learning include supervised, unsupervised, regression, classification, reinforcement, and clustering, among others.

Among these machine learning types are a number of model implementations, such as linear regression, logistic regression, evolution strategies(ES), convolutional neural networks (CNN), deconvolutional neural networks (DNN), generative adversarial networks (GAN), recurrent neural networks (RNN), mixture-of-experts (MoE), transformers, support vector machines (SVM), Bayesian networks, k-nearest neighbors (KNN), decision trees, gradient boosting machines (GBM), autoencoders, long short-term memory networks (LSTM), reinforcement learning models (RL), imitation learning models (IL), and random forest, among others. As known to a person of ordinary skill in the art, one or more machine learning models can be configured and trained for performing one or more tasks during runtime of a machine learning module.

As known to a person of ordinary skill in the art, the output of a machine learning model is based at least in part on its type, implementation, configuration, and/or training data. The data that models are trained on (e.g., training data) can include one or more data types. In some embodiments, the training data of a model can be changed, updated, and/or supplemented throughout training and/or inference (i.e., runtime) of the model.

The systems, methods, and/or computing devices of the present disclosure can include machine learning modules. A “machine learning module” is a software module and/or hardware module including computer-executable instructions to configure, train, and/or deploy (e.g., execute) one or more machine learning models.

Some aspects of the present disclosure include subject matter corresponding to the gameplay of video game applications. As known to a person of ordinary skill in the art, the gameplay of a video game is commonly known as occurring among a game session within one or more instances of one or more virtual interactive environments. The gameplay of a video game provides interactivity with one or more aspects of a video game.

A game session may include a number of player characters and/or non-player characters. As known to those of skill in the art, player characters are character models that can be controlled or directed (at least primarily) by users or players through inputs at their respective computing devices and can perform gameplay actions or commands. “Non-player characters” (also referred to herein as “NPCs”) are characters that are not or cannot be controlled and/or directed (primarily by users or players). Rather, NPCs can be configured with computer executable instructions to perform one or more gameplay tasks and/or actions, with and/or without the need for input or interaction from a user/player or player character.

A game session may include a number of player objects. Player objects can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in a game session, including, in some instances, by controlling player characters which in turn causes the objects to be controlled.

For simplicity, player characters and player objects disclosed are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Some aspects of the present disclosure include subject matter corresponding to data of video game applications. As known to a person of ordinary skill in the art, data of a video game application can include data such as state data, simulation data, rendering data, digital assets, and other data of the like.

State data is commonly known as data describing a state of a player character, virtual interactive environment, and/or other virtual objects, actors, or entities-in whole or in part-at one or more instances or periods of time during a game session of a video game. For example, state data can include the current location and condition of one or more player characters among a virtual interactive environment at a given time, frame, or duration of time or number of frames.

State data can be simulated and/or generated by a simulator of a video game engine to produce simulation data. Simulation data, or state simulation data, is commonly known as the underlying data corresponding to the simulated aspects (e.g., physics and other corresponding mechanics) to drive simulation of a model or object in a game engine. For example, simulation data can include the joint and structural configuration of a character model and corresponding physical forces or characteristics applied to it at instance or period of time during gameplay, such as a “frame”, to create animations, among other things. Accordingly, simulation data can correspond to the positioning, movements, and/or animation of objects and/or characters in a video game.

Render Data is commonly known as the underlying data corresponding to rendering (e.g., visual, and auditory rendering) aspects of a game session, which are rendered (e.g., for output to an output device) by a game engine. For example, render data can include data corresponding to the rendering of graphical, visual, auditory, and/or haptic output of a video game, among other things.

Digital game assets (or game assets in short) can include virtual objects, character models, actors, entities, geometric meshes, textures, terrain maps, animation files, audio files, digital media files, font libraries, visual effects, and other digital assets commonly used in video games of the like.

In some embodiments, a game session or gameplay is based in part on the data of a video game. One or more aspects of gameplay (e.g., rendering, simulation, state, gameplay actions of player characters) uses, produces, generates, and/or modifies game data. Likewise, gameplay events, objectives, triggers, and other aspects, objects, or elements of the like also use, produce, generate, and/or modify data of a video game.

The data of a video game may be updated, versioned, and/or stored periodically as a number of files to a computing device. Additionally, game data, or copies and/or portions thereof, can be stored, referenced, categorized, or placed into a number of buffers or storage buffers. A buffer can be configured to capture particular data, or data types, of game data for processing and/or storage.

Some aspects of the present disclosure include subject matter corresponding to video games, including video game components corresponding to the software of a video game. As known to a person of ordinary skill in the art, game code is software defining the gameplay, features, and aspects of a video game whereas a game engine provides underlying frameworks and software that support and facilitate execution of the game code (e.g., gameplay)

As a non-limiting descriptive example, a game engine includes, among other things, a renderer, simulator, and stream layer. A game engine uses game data (e.g., state data, render data, simulation data, audio data, and other data types of the like) to generate and/or render one or more outputs (e.g., visual output, audio output, and haptic output) for one or more computing devices. In some embodiments, a game engine is a distributable computer executable runtime portion of development software, such as a video game development engine.

A renderer is a graphics framework that manages the production of graphics corresponding to lighting, shadows, textures, user interfaces, and other effects to game assets of the like among a game engine. A simulator refers to a framework that manages simulation aspects corresponding to physics and other corresponding mechanics used in part for animations and/or interactions of gameplay objects, entities, characters, lighting, gases, and other game assets or effects of the like. A stream layer is a software layer that allows a renderer and simulator to execute independently of one another among a game engine by providing a common execution stream for renderings and simulations to be produced and/or synchronized (e.g., scheduled) at and/or during runtime.

A game engine also includes an audio engine or audio renderer that produces and synchronizes audio playback with or among the common execution of a stream layer. For example, an audio engine of a game engine can use game data to produce audio output and/or haptic output from game data.

As used herein in some embodiments, video game applications can also use and/or include Software Development Kits (SDKs), Application Program Interfaces (APIs), Dynamically Linked Libraries (DLLs), and other software libraries, components, modules, shims, or plugins that provide and/or enable a variety of functionality; such as—but not limited to—graphics, audio, font, or communication support, establishing and maintaining service connections, performing authorizations, and providing anti-cheat and anti-fraud monitoring and detection, among other things.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated (e.g., among a computing device). It has proven convenient at times, principally for reasons of common usage, to refer to these signals as bits, values, elements, symbols, characters, terms, numbers, or the like.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A system comprising:
one or more processors; and
one or more memory devices communicatively coupled to the one or more processors, the one or more memory devices storing computer-executable instructions corresponding to a spectating application that, during runtime execution by the one or more processors, causes at least one of the one or more processors to:
access, from a spectating service over a network to display the spectating application, a plurality of game sessions corresponding to one or more video game applications, wherein the plurality of game sessions is each available for spectating;
receive a selection, from among the accessed plurality of game sessions displayed on the spectating application, a game session among the plurality to spectate gameplay of the game session;
send, in response to the selection of the game session, a request to spectate the gameplay of the game session to the spectating service;
receive, in response to the request, a data stream corresponding to the game session from the spectating service, the data stream comprising at least simulation state data packets (SSDPs) defining one or more states of gameplay of the game session;
render, by a renderer of the spectating application, a first view of gameplay based at least in part on the data stream, wherein the renderer of the spectating application differs from the renderer of the video game application that produced the game session;
select, among a user interface of the spectating application, a first visual modification feature to apply to the first view rendered; and
render a second view of gameplay based at least in part on the data stream and the first visual modification feature, wherein the second view renders at least one or more visual elements that differ from the first view.

2. The system of claim 1, wherein the plurality of game sessions comprises:
a. live gameplay that is currently being streamed to the spectating service, and
b. replays of gameplay that are stored by the spectating service.

3. The system of claim 1, wherein a request to spectate the game session also includes at least one of the following requests to the spectating service to receive:
a. a data stream of the game session at a specified quality level,
b. a renderer for the spectating application that is based at least in part on data corresponding to the video game application of the game session,
c. an update to a renderer of the spectating application that corresponds to the video game application of the game session, or
d. an audio stream corresponding to the game session.

4. The system of claim 1, wherein a visual modification feature comprises at least one of:
a. camera angle changes,
b. lighting adjustments,
c. environmental alterations,
d. character alterations, or
e. user interface overlays.

5. The system of claim 1, wherein the renderer of the spectating application is a machine learning-based neural renderer and wherein the renderer of the video game application that produced the game session is a video game engine configured to produce real time graphics based at least in part on game data.

6. The system of claim 1, further configured to render an estimated reference frame corresponding to the first view, wherein the second view is periodically compared to estimated reference frame to detect one or more rendering deviations among the frame of the second view, including detecting at least one of pixel variation, object positioning, animation inconsistencies, or environmental lighting conditions.

7. The system of claim 6, wherein in response to one or more deviations detected, a request to receive a reference frame stream is corresponding to the game session is made to the spectating service.

8. A computer implemented method of a spectating application configured to:
access, from a spectating service over a network to display the spectating application, a plurality of game sessions corresponding to one or more video game applications, wherein the plurality of game sessions is each available for spectating;
receive a selection, from among the accessed plurality of game sessions displayed on the spectating application, a game session among the plurality to spectate gameplay of the game session;
send, in response to the selection of the game session, a request to spectate the gameplay of the game session to the spectating service;
receive, in response to the request, a data stream corresponding to the game session from the spectating service, the data stream comprising at least simulation state data packets (SSDPs) defining one or more states of gameplay of the game session;
render, by a renderer of the spectating application, a first view of gameplay based at least in part on the data stream, wherein the renderer of the spectating application differs from the renderer of the video game application;
select, among a user interface of the spectating application, a first visual modification feature to apply to the first view rendered; and
render a second view of gameplay based at least in part on the data stream and the first visual modification feature, wherein the second view renders at least one or more visual elements that differ from the first view.

9. The method of claim 8, wherein the plurality of game sessions comprises:
a. live gameplay that is currently being streamed to the spectating service, and
b. replays of gameplay that are stored by the spectating service.

10. The method of claim 8, wherein a request to spectate the game session also includes at least one of the following requests to the spectating service to receive:
a. a data stream of the game session at a specified quality level,
b. a renderer for the spectating application that is based at least in part on data corresponding to the video game application of the game session,
c. an update to a renderer of the spectating application that corresponds to the video game application of the game session, or
d. an audio stream corresponding to the game session.

11. The method of claim 8, wherein a visual modification feature comprises at least one of:
a. camera angle changes,
b. lighting adjustments,
c. environmental alterations,
d. character alterations, or
e. user interface overlays.

12. The method of claim 8, wherein the renderer of the spectating application is a machine learning-based neural renderer and wherein the renderer of the video game application that produced the game session is a video game engine configured to produce real time graphics based at least in part on game data.

13. The method of claim 12, further configured to render an estimated reference frame corresponding to the first view, wherein the second view is periodically compared to estimated reference frame to detect one or more rendering deviations among the frame of the second view, including detecting at least one of pixel variation, object positioning, animation inconsistencies, or environmental lighting conditions.

14. The method of claim 13, wherein in response to one or more deviations detected, a request to receive a reference frame stream is corresponding to the game session is made to the spectating service.

15. A computer readable medium storing computer-executable instructions defining at least a spectating application configured to:
access, from a spectating service over a network to display the spectating application, a plurality of game sessions corresponding to one or more video game applications, wherein the plurality of game sessions is each available for spectating;
receive a selection, from among the accessed plurality of game sessions displayed on the spectating application, a game session among the plurality to spectate gameplay of the game session;
send, in response to the selection of the game session, a request to spectate the gameplay of the game session to the spectating service;
receive, in response to the request, a data stream corresponding to the game session from the spectating service, the data stream comprising at least simulation state data packets (SSDPs) defining one or more states of gameplay of the game session;
render, by a renderer of the spectating application, a first view of gameplay based at least in part on the data stream, wherein the renderer of the spectating application differs from the renderer of the video game application;
select, among a user interface of the spectating application, a first visual modification feature to apply to the first view rendered; and
render a second view of gameplay based at least in part on the data stream and the first visual modification feature, wherein the second view renders at least one or more visual elements that differ from the first view.

16. The computer readable medium of claim 15, wherein the plurality of game sessions comprises:
a. live gameplay that is currently being streamed to a spectating service, and
b. replays of gameplay that are stored by the spectating service.

17. The computer readable medium of claim 15, wherein a request to spectate the game session also includes at least one of the following requests to the spectating service to receive:
a. a data stream of the game session at a specified quality level,
b. a renderer for the spectating application that is based at least in part on data
corresponding to the video game application of the game session,
c. an update to a renderer of the spectating application that corresponds to the video game application of the game session, or
d. an audio stream corresponding to the game session.

18. The computer readable medium of claim 15, wherein a visual modification feature comprises at least one of:
a. camera angle changes,
b. lighting adjustments,
c. environmental alterations,
d. character alterations, or
e. user interface overlays.

19. The computer readable medium of claim 15, wherein the renderer of the spectating application is a machine learning-based neural renderer and wherein the renderer of the video game application that produced the game session is a video game engine configured to produce real time graphics based at least in part on game data.

20. The computer readable medium of claim 19, further configured to render an estimated reference frame corresponding to the first view, wherein the second view is periodically compared to estimated reference frame to detect one or more rendering deviations among the frame of the second view, including detecting at least one of pixel variation, object positioning, animation inconsistencies, or environmental lighting conditions.
